(19) United States
(12) Patent Application Publication
(10) Pub. No.: US 2005/0044024 A1
(43) Pub. Date: Feb. 24, 2005

(54) Systems, methods and computer program products for providing tax-deferred liquidity to owners of highly concentrated positions in equity securities

(76) Inventor: Joseph P. Davis III, Carrboro, NC (US)

Correspondence Address: Needham James Boddie, II;Myers Bigel Sibley & Sajovec, P.A., P. O. Box 37428, Raleigh, NC, 27627, US

(21) Appl. No.: 10/909,874

(22) Filed: Aug. 2, 2004

Related U.S. Application Data
(60) Provisional application No. 60/496,963, filed on Aug. 21, 2003.

(51) Int. Cl. G06F 17/60

(52) U.S. Cl. 705/35; 705/36

(57) ABSTRACT

An investment strategy for high net worth persons whose wealth is concentrated in security holdings is provided. An underwriter accepts deposits of equity securities into an exchange fund from owners. Each owner is provided with a respective ownership position in the exchange fund. The underwriter provides a loan with warrants attached to each of the owners, wherein each loan is based on a percentage of the market value of the equity securities deposited by a respective owner at the time of deposit. At a future date, underwriter determines if current market value of an owner's equity securities in exchange fund is less than the market value at time of deposit. If not, underwriter may allow the owner to repurchase equity securities at the current market value. If so, the underwriter requires the owner to repurchase the equity securities at the market value at the time of deposit.

### RELATED APPLICATION

This application claims the benefit of U.S. Provisional Application No. 60/496,963 filed Aug. 21, 2003, the disclosure of which is incorporated herein by reference in its entirety as if set forth fully herein.

### FIELD OF THE INVENTION

The present invention relates generally to financial management and, more particularly, to financial management systems, methods and computer program products.

### BACKGROUND OF THE INVENTION

As financial markets move to reclaim investor confidence and profitability, investment managers continue to seek new strategies to attract, engage and retain high net worth clients. Opportunely, many high net worth individuals desire a viable solution to reduce risk, diversify holdings and derive liquidity from highly concentrated stock portfolios. Successful entrepreneurs and venture capitalists often face the challenge of transferring wealth from restrictive publicly traded 144 securities.

Restricted securities include securities acquired in unregistered, private sales from the issuer or from an affiliate of the issuer. Investors typically receive restricted securities through private placement offerings, Regulation D offerings, employee stock benefit plans, as compensation for professional services, or in exchange for providing “seed money” or start-up capital to the company. U.S. Securities and Exchange Commission (SEC) Rule 144 permits the public resale of restricted securities if a number of conditions are met, including how long the securities are held, the way in which they are sold, and the amount that can be sold at any one time.

Investors owning restrictive securities historically have had the following options with respect to reducing risk, diversifying their holdings, and/or deriving liquidity: 1) they can sell a percentage of their securities and diversify; 2) they can borrow against a percentage of their holdings; 3) they can collar and monetize their position; and/or 4) they can deposit the securities into a fund for improved diversification. Unfortunately, with the first alternative, low-cost-basis stock may present a serious tax liability. Additionally, the investor may find it disadvantageous to sell, or may be restricted from selling, his or her holding in a company.

With respect to the second alternative, the investor would typically incur interest cost at LIBOR (London Interbank Offered Rate) plus 200 basis points or more and additional market risk. LIBOR is a widely used benchmark or reference rate for short term interest rates and is the rate of interest at which banks borrow funds from other banks in the London interbank market.

With respect to the third alternative, risk may be reduced, but upside potential on the stock may also be reduced. With respect to the fourth alternative, restrictions may exist and liquidity may not be established.

### SUMMARY OF THE INVENTION

In view of the above, methods, computer systems and computer program products for implementing an exchange fund for high net worth (HNW) individuals and investors are provided. Initially, an underwriter accepts deposits of equity securities (e.g., restricted equity securities) into an exchange fund from a plurality of owners of equity securities. The underwriter may verify that an aggregate diversity requirement for the exchange fund is satisfied when accepting deposits of equity securities into the exchange fund. If the aggregate diversity requirement is not met, one or more owners may be refused participation in the exchange fund.

Upon depositing equity securities in the exchange fund, each owner is provided with a respective ownership position in the exchange fund, and each respective ownership position is proportionate to the market value of the equity securities deposited by each owner at the time of deposit. The underwriter provides a loan to each of the owners, wherein each loan is based on a percentage of the market value of the equity securities deposited by a respective owner at the time of deposit. Each loan is required to be paid in full at a respective future maturity date. The underwriter accepts from each owner a warrant to repurchase the equity securities deposited by each respective owner at a future warrant maturity date and at the market value at the time of deposit.

According to embodiments of the present invention, the underwriter may bundle the warrants and loans associated with an exchange fund to create a plurality of exchange notes. Each exchange note may have a rate of return and a maturity date at which time the exchange note can be redeemed. The underwriter then sells the exchange notes to investors.

At a future warrant maturity date, the underwriter determines if the current market value of an owner's equity securities in the exchange fund is less than the market value at the time of deposit in the exchange fund. If the market value is greater than or equal to the market value at the time of deposit, the underwriter allows the owner to repurchase the equity securities at the current market value. If the market value is less than the market value at the time of deposit, the underwriter requires the owner to repurchase the equity securities at the market value at the time of deposit.

Embodiments of the present invention can provide an investment strategy alternative for high net worth persons whose wealth is largely concentrated in security holdings. Embodiments of the present invention can provide investors with tax-deferred liquidity while the underwriting investment management firm can achieve market outperformance and the retention and growth of high net worth clients. Investing in an exchange fund, according to embodiments of the present invention, can provide diversity and risk management for the HNW, as well as offering a portfolio that can be used as collateral for an exchange loan. With the establishment of an exchange loan secured by portfolio holdings, the HNW individual has access to desired cash flow. Underwriters typically will collect a fee for the set-up and ongoing use of exchange loans. In addition, the underwriter can package multiple exchange loans in the form of EXCHANGE NOTES™, which can be sold to investors. EXCHANGE NOTES™ may trade actively in secondary markets. For their investment, note owners will receive returns equal to an underlying portfolio plus an annual fee (e.g., 1%). Investors will be guaranteed a full return of principal invested, or the return of the underlying portfolio, whichever is greater at maturity.

Embodiments of the present invention can potentially provide benefits to all parties involved. For example, benefits provided to underwriters include a recurring revenue source, low-risk, high-return potential, consistent performance to investors, and the appearance of an innovator in the field. Benefits provided to HNW individuals include low-cost tax-deferred liquidity, expert money management, and market outperformance potential. Benefits to investors include low-risk, high-return potentials. Benefits to securities broker include attracting HNW individuals, maintaining a relationship with HNW individuals for a period of time, and attractive commission schedules.

### BRIEF DESCRIPTION OF THE DRAWINGS

FIG. 1 is a block diagram that illustrates operations, systems and computer program products for implementing methods of providing tax-deferred liquidity to owners of highly concentrated positions in equity securities, according to embodiments of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the term “and/or” includes any and all combinations of one or more of the associated listed items.

Definitions

HNW Individual: A high net worth (HNW) individual has a high concentration of their net worth in one or very few securities. Many of these individuals want cash for lifestyle or other investment purposes, but they do not wish to incur the current tax liability for liquidating stock positions. A HNW individual can deposit his or her highly concentrated security position into an exchange fund or multiple funds, then assigns a portion of the fund to an underwriter as collateral for a loan equal to a certain percent (e.g., 65%) of current market value. The HNW individual pays no current tax, maintains ownership of underlying securities, and is availed of cash at significantly lower net cost than borrowing through conventional credit channels, i.e., banks. A warrant is packaged with a note to the loan holder.

EXCHANGE NOTE™—A debt instrument issued by an underwriter. Investors will receive a return commensurate with an underlying equity portfolio, typically an exchange fund. In addition, investors will receive an annual fee equal to 100 basis points (b.p.) or 1% of the investment amount. At maturity investors are guaranteed a full return of principal or 100% of the underlying portfolio performance, whichever is greater. The maturity of any EXCHANGE NOTE™ will be equal to the term of the underlying portfolio. Typically, the term will be 7-10 years, but other terms may be utilized, also.

Exchange Fund—a professionally managed investment vehicle that can deliver a diversified equity portfolio to High Net Worth (HNW) individuals who have a high concentration of wealth in a single security. Example: An individual, through whatever means, has a net worth of $100 million, $90 million of which is in one stock holding. By depositing the stock into an exchange fund the investor receives a proportionate ownership in a diversified portfolio that is professionally selected and managed. Typical exchange funds can “mirror” the S&P 500 index, thus providing investors with diversity and risk management.

Underwriter—The entity that establishes Exchange Loans, secured by exchange fund positions, for HNW clients. Exchange Loans are based on a certain percent (e.g., 65%) loan-to-value for securities that are deposited into an exchange fund. Underwriters will “package” multiple outstanding Exchange Loans and create EXCHANGE NOTES™ which will then be made available to investors. The underwriter typically receives a set-up fee (e.g., 1%) on all loans, an annual fee (e.g., 50 b.p.) for all outstanding loan balances and a warrant fee.

Exchange Loan—A loan extended to HNW individuals who have deposited securities into an exchange fund. Loan amounts are based on a certain, percent (e.g., 65%) loan-to-value of the underlying security's market value at an agreed upon date. Attached to the loan is a warrant to purchase the underlying security at a specific price.

According to some embodiments of the present invention, an individual (e.g., a HNW individual) invests a highly concentrated stock position into an exchange fund or series of exchange funds. With appropriate documentation, an underwriter establishes an exchange loan with a credit limit equal to a certain percent (e.g., 65%) of the market value of the underlying securities, using exchange fund shares as collateral. The individual may access all or part of the exchange loan up to the credit limit during a designated time period (e.g., years 1, 2 or 3). Once extended, the exchange loan outstanding balance will remain in place until such time as the underlying portfolio is distributed, e.g., 7-10 years. The individual will typically pay a one-time set up fee of (e.g., 2%) of the exchange loan, and will agree to pay a certain percent (e.g., 2%) annually for any outstanding balance on the exchange loan.

According to some embodiments of the present invention, once multiple exchange loans are established with multiple HNW individuals, the underwriter will combine/package the exchange loans as an EXCHANGE NOTE™ that will be sold to investors at par. It is possible that EXCHANGE NOTES™ may be traded on a secondary market at some time based on a bid/ask spread. Investors will receive annual returns (e.g., 1%) and will have performance of the underlying security subordinated to them by borrowers through the use of warrants. At exchange fund maturity, investors will receive a 100% return of principal. If current market value of an underlying security is less than original investment, the HNW individual is liable for any difference and will have a set period of time (e.g., 10 business days) to deliver cash or cash equivalents to the investors. The HNW individual may also have the option to deliver funds from his or her remaining exchange fund balance at maturity.

To unwind an EXCHANGE NOTES™ transaction, according to some embodiments of the present invention, the noteholder sells the warrants to the underwriter for cash, and the notemaker buys back the warrants from the underwriter for cash. The effect is the noteholder gains from sale of warrants equal to underlying security performance, and the notemaker incurs warrant loss to offset “phantom” gain above strike price.

The present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. However, software embodiments of the present invention do not depend on implementation with a particular programming language. It will be further appreciated that the functionality of any or all of the program modules may also be implemented using discrete hardware components, one or more application specific integrated circuits (ASICs), or a programmed digital signal processor or microcontroller.

The present invention is described below with reference to block diagram and flowchart illustrations of methods, apparatus (systems) and computer program products according to embodiments of the invention. It will be understood that each block of the block diagrams and/or flowchart illustrations, and combinations of blocks, can be implemented by computer program instructions and/or hardware operations. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagram and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function specified in the block diagram and/or flowchart block or blocks.

The computer program instructions may also be loaded onto a computer or other programmable data processing apparatus to cause a series of operational steps to be performed on the computer or other programmable apparatus to produce a computer implemented process or method such that the instructions which execute on the computer or other programmable apparatus provide steps for implementing the functions specified in the block diagram and/or flowchart block or blocks.

It should be noted that, in some alternative embodiments of the present invention, the functions noted in the blocks may occur out of the order noted in the figures. For example, two blocks shown in succession may in fact be executed substantially concurrently or the blocks may sometimes be executed in the reverse order, depending on the functionality involved. Furthermore, in certain embodiments of the present invention, such as object oriented programming embodiments, the sequential nature of the flowcharts may be replaced with an object model such that operations and/or functions may be performed in parallel or sequentially.

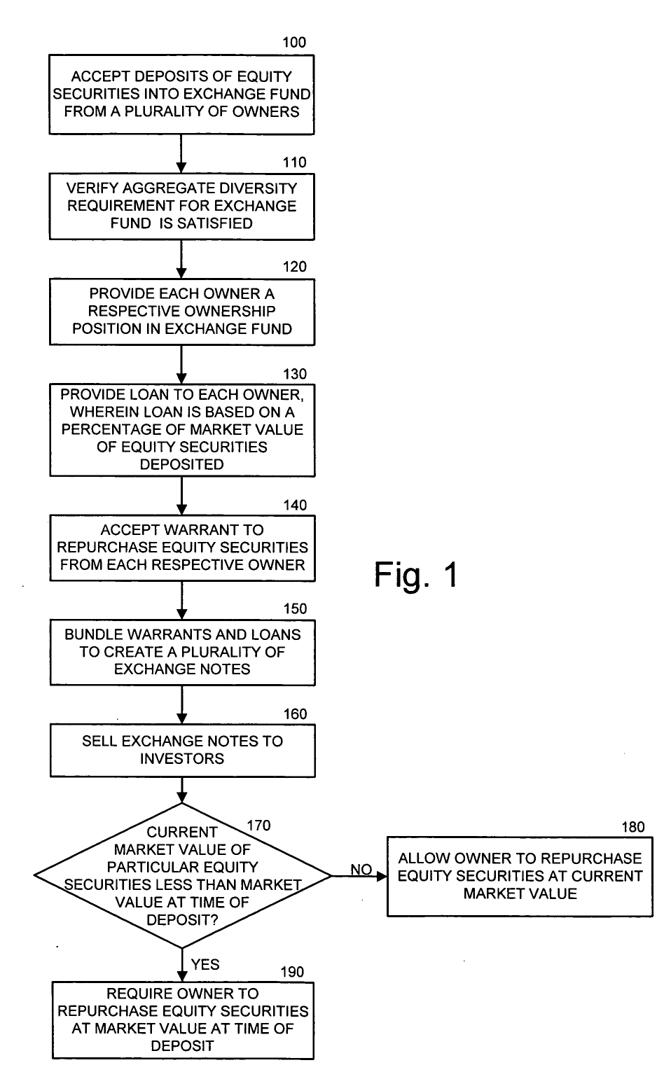

Referring to FIG. 1, operations performed by an underwriter to implement embodiments of the present invention are illustrated. These operations may be implemented manually, may be implemented via one or more computers, or may be implemented via a combination of manual and computer operations. Initially, an underwriter accepts deposits of equity securities (e.g., restricted equity securities) into an exchange fund from a plurality of owners of equity securities (Block 100). Each equity security owner maintains ownership rights in the owner's respective equity securities. According to embodiments of the present invention, an exchange fund may have a requirement that equity securities deposited therein meet an aggregate diversity requirement. Such a requirement would be at the discretion of a manager of the exchange fund. An exemplary aggregate diversity requirement would be that no one equity position constitute more than five percent (5%) of the total portfolio. Virtually any percentage of the total portfolio may be selected. Accordingly, the underwriter may verify that the aggregate diversity requirement is satisfied when accepting deposits of equity securities into the exchange fund (Block 110). If the aggregate diversity requirement is not met, one or more owners may be refused participation in the exchange fund.

Upon depositing equity securities in the exchange fund, each owner is provided with a respective ownership position in the exchange fund (Block 120). Each respective ownership position is proportionate to the market value of the equity securities deposited by each owner at the time of deposit.

The underwriter provides a loan to each of the owners, wherein each loan is based on a percentage of the market value of the equity securities deposited by a respective owner at the time of deposit (Block 130). Each loan is required to be paid in full at a respective future maturity date. The underwriter accepts from each owner a warrant to repurchase the equity securities deposited by each respective owner at a future warrant maturity date and at the market value at the time of deposit (Block 140).

According to embodiments of the present invention, the underwriter may bundle the warrants and loans associated with an exchange fund to create a plurality of exchange notes (Block 150). Each exchange note may have a rate of return and a maturity date at which time the exchange note can be redeemed. The underwriter then sells the exchange notes to investors (Block 160).

At a future warrant maturity date, the underwriter determines if the current market value of an owner's equity securities in the exchange fund is less than the market value at the time of deposit in the exchange fund (Block 170). If the market value is greater than or equal to the market value at the time of deposit, the underwriter may allow the owner to repurchase the equity securities at the current market value (Block 180). If the market value is less than the market value at the time of deposit, the underwriter requires the owner to repurchase the equity securities at the market value at the time of deposit (Block 190). In other words, the owner must make up the difference if an equity security has lost value. This may be done via a cash transaction, via another equity security transaction, or a combination thereof. To further reduce default risk, an insurance rider may be available to the note holder for an additional fee.

### EXAMPLE 1

Sarah has a $10 million 144 (SEC Rule 144) control position in XYZ Corporation. Sarah contracts for EXCHANGE NOTESTM to receive tax-deferred liquidity. She deposits her securities into an exchange fund. The underwriter accepts an assignment of up to 65% of the current market value and extends interest-free credit to Sarah. Sarah is obligated to repay loan if performance of her securities in the exchange fund is not up to par. Underwriter receives market performance plus 100 basis points (b.p.) annually with a principal guarantee at maturity in eight years (based on the maturity of the underlying exchange fund). Underwriter packages multiple loans and sells as EXCHANGE NOTES™. Table 1 illustrates exemplary distribution of fees associated with Sarah's participation in the exchange fund.

TABLE 1

| | |
|---|---|
| PROFITABILITY OVERVIEW | DISTRIBUTION OF FEES |

Initial Cost (one-time fees)

| | | | |
|---|---|---|---|
| Set-up fee | 200 b.p. of loan | Underwriter | 100 b.p. |
| | amount | | |
| | | Creator | 100 b.p. |
| Warrant Fee | 10 cents per share | Underwriter | 10 cents |
| | transaction fee | | per share |
| | | | warrant |
| | | | fee |

Annual Fees

| | | | |
|---|---|---|---|
| Exchange loan | 200 b.p. | Underwriter | 50 b.p. |
| fee | | | |
| | | Exchange | 100 b.p. |
| | | Note | |
| | | Investor | |
| | | Exchange | 25 b.p. |
| | | Fund | |
| | | Creator | 25 b.p. |

### EXAMPLE 2

Tracey deposits shares of Microsoft Corporation currently valued at $10,000,000 into exchange fund. Underwriter loans Tracey $6,500,000. Tracey pays the underwriter 2% loan origination fee plus 2% annual loan fee. Underwriter attaches warrants to the shares and sells a $6,500,000 exchange note to an investor.

In year 8, the exchange fund seasons and it is time to unwind the transactions. If the current market value of the shares of the exchange fund is $15,000,000 Tracey's net value is $5,250,000. An investor exercises the warrants associated with the shares and has a net value of $9,750,000 plus an annual percentage fee (e.g., 1%).

If the current market value of the shares of the exchange fund is $9,000,000 Tracey's net value is $2,500,000 (less fees). An investor does not exercise the warrants associated with the shares (i.e., the warrants have no value). The investor's net value is $6,500,000. Tracey is required to make up the difference such that the investor receives a return of principal plus an annual percentage fee (e.g., 1%). In the unlikely event that Tracey has no capacity to repay, the note holder who purchased the insurance rider shall be made whole by the underwriting insurance company.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. The invention is defined by the following claims, with equivalents of the claims to be included therein.

1. A method of providing tax-deferred liquidity to owners of highly concentrated positions in equity securities, the method comprising the following steps performed by an underwriter of an exchange fund, wherein the exchange fund comprises a plurality of diversified equity securities, and wherein the exchange fund has a maturity date:
accepting deposits of equity securities into the exchange fund from a plurality of owners of equity securities, wherein each equity securities owner maintains ownership rights in the owner's respective equity securities;
providing each of the owners a respective ownership position in the exchange fund, wherein each respective ownership position is proportionate to the market value of the equity securities deposited by each owner at the time of deposit;
providing a loan to each of the owners, wherein each loan is based on a percentage of the market value of the equity securities deposited by a respective owner at the time of deposit, wherein each loan is required to be paid in full at a respective future maturity date; and
accepting from each owner a warrant to repurchase the equity securities deposited by each respective owner at a future warrant maturity date and at the market value at the time of deposit.

2. The method of claim 1, further comprising:
bundling the warrants and loans to create a plurality of exchange notes, wherein each exchange note has a rate of return and a maturity date at which time the exchange note can be redeemed; and
selling the exchange notes to investors.

3. The method of claim 1, wherein the exchange fund has a requirement that equity securities deposited therein meet an aggregate diversity requirement, and wherein accepting deposits of equity securities into the exchange fund from the plurality of owners comprises verifying that the aggregate diversity requirement is satisfied.

4. The method of claim 1, wherein providing a loan to each of the owners comprises providing a loan of less than or equal to about 65% of the present market value of the respective equity securities deposited by each owner.

5. The method of claim 1, further comprising:
determining the current market value of an owner's equity securities in the exchange fund at a respective warrant maturity date;
allowing the owner to repurchase the equity securities at the current market value if the current market value is greater than or equal to the market value of the equity securities at the time of deposit; and
requiring the owner to repurchase the equity securities at the market value of the equity securities at the time of deposit if the current market value is less than the market value of the equity securities at the time of deposit.

6. The method of claim 1, wherein the equity securities are restricted equity securities or low cost basis securities.

7. An underwriter system for providing tax-deferred liquidity to owners of highly concentrated positions in equity securities, comprising:
an exchange fund that comprises a plurality of diversified equity securities and that has a maturity date;
means for accepting deposits of equity securities into the exchange fund from a plurality of owners of equity securities, wherein each equity securities owner maintains ownership rights in the owner's respective equity securities;
means for providing each of the owners a respective ownership position in the exchange fund, wherein each respective ownership position is proportionate to the market value of the equity securities deposited by each owner at the time of deposit;
means for providing a loan to each of the owners, wherein each loan is based on a percentage of the market value of the equity securities deposited by a respective owner at the time of deposit, wherein each loan is required to be paid in full at a respective future maturity date; and
means for accepting from each owner a warrant to repurchase the equity securities deposited by each respective owner at a future warrant maturity date and at the market value at the time of deposit.

8. The system of claim 7, further comprising:
means for bundling the warrants and loans to create a plurality of exchange notes, wherein each exchange note has a rate of return and a maturity date at which time the exchange note can be redeemed; and
means for selling the exchange notes to investors.

9. The system of claim 7, wherein the exchange fund has a requirement that equity securities deposited therein meet an aggregate diversity requirement, and wherein the means for accepting deposits of equity securities into the exchange fund from the plurality of owners comprises means for verifying that the aggregate diversity requirement is satisfied.

10. The system of claim 7, wherein the means for providing a loan to each of the owners comprises means for providing a loan of less than or equal to about 65% of the present market value of the respective equity securities deposited by each owner.

11. The system of claim 7, further comprising:
means for determining the current market value of an owner's equity securities in the exchange fund at a respective warrant maturity date;
means for allowing the owner to repurchase the equity securities at the current market value if the current market value is greater than or equal to the market value of the equity securities at the time of deposit; and
means for requiring the owner to repurchase the equity securities at the market value of the equity securities at the time of deposit if the current market value is less than the market value of the equity securities at the time of deposit.

12. The system of claim 7, wherein the equity securities are restricted equity securities.

13. A computer program product for providing tax-deferred liquidity to owners of highly concentrated positions in equity securities, the computer program product comprising a computer usable storage medium having computer readable program code embodied in the medium, the computer readable program code comprising:
computer readable program code that accepts deposits of equity securities into an exchange fund from a plurality of owners of equity securities, wherein each equity securities owner maintains ownership rights in the owner's respective equity securities;
computer readable program code that provides each of the owners a respective ownership position in the exchange fund, wherein each respective ownership position is proportionate to the market value of the equity securities deposited by each owner at the time of deposit;
computer readable program code that provides a loan to each of the owners, wherein each loan is based on a percentage of the market value of the equity securities deposited by a respective owner at the time of deposit, wherein each loan is required to be paid in full at a respective future maturity date; and
computer readable program code that accepts from each owner a warrant to repurchase the equity securities deposited by each respective owner at a future warrant maturity date and at the market value at the time of deposit.

14. The computer program product of claim 13, further comprising:
computer readable program code that bundles the warrants and loans to create a plurality of exchange notes, wherein each exchange note has a rate of return and a maturity date at which time the exchange note can be redeemed; and
computer readable program code that sells the exchange notes to investors.

15. The computer program product of claim 13, wherein the exchange fund has a requirement that equity securities deposited therein meet an aggregate diversity requirement, and wherein the computer readable program code that accepts deposits of equity securities into the exchange fund from the plurality of owners comprises computer readable program code that verifies that the aggregate diversity requirement is satisfied.

16. The computer program product of claim 13, wherein the computer readable program code that provides a loan to each of the owners comprises computer readable program code that provides a loan of less than or equal to about 65% of the present market value of the respective equity securities deposited by each owner.

17. The computer program product of claim 13, further comprising:
computer readable program code that determines the current market value of an owner's equity securities in the exchange fund at a respective warrant maturity date;
computer readable program code that allows the owner to repurchase the equity securities at the current market value if the current market value is greater than or equal to the market value of the equity securities at the time of deposit; and
computer readable program code that requires the owner to repurchase the equity securities at the market value of the equity securities at the time of deposit if the current market value is less than the market value of the equity securities at the time of deposit.

18. The computer program product of claim 13, wherein the equity securities are restricted equity securities.

19. A method of providing tax-deferred liquidity to owners of highly concentrated positions in equity securities, the method comprising the following steps performed by an underwriter of an exchange fund:
accepting deposits of equity securities into the exchange fund from a plurality of owners of highly concentrated positions in the equity securities;
providing each of the owners a respective ownership position in the exchange fund;
providing a loan to each of the owners, wherein each loan is based on the market value of the equity securities deposited by a respective owner at the time of deposit; and
accepting from each owner a warrant to repurchase the equity securities deposited by each respective owner at a future warrant maturity date.

20. The method of claim 19, wherein the exchange fund comprises a plurality of diversified equity securities, and wherein the exchange fund has a maturity date.

21. The method of claim 19, wherein each equity securities owner maintains ownership rights in the owner's respective equity securities.

22. The method of claim 19, wherein each respective ownership position is proportionate to the market value of the equity securities deposited by each owner at the time of deposit.

23. The method of claim 19, wherein each loan is based on a percentage of the market value of the equity securities deposited by a respective owner at the time of deposit, and wherein each loan is required to be paid in full at a respective future maturity date.

24. The method of claim 19, wherein accepting from each owner a warrant to repurchase the equity securities deposited by each respective owner at a future warrant maturity date comprises accepting from each owner a warrant to repurchase the equity securities deposited by each respective owner at the market value at the time of deposit.

25. The method of claim 19, further comprising:
bundling the warrants and loans to create a plurality of exchange notes, wherein each exchange note has a rate of return and a maturity date at which time the exchange note can be redeemed; and
selling the exchange notes to investors.

26. The method of claim 19, wherein the exchange fund has a requirement that equity securities deposited therein meet an aggregate diversity requirement, and wherein accepting deposits of equity securities into the exchange fund from the plurality of owners comprises verifying that the aggregate diversity requirement is satisfied.

27. The method of claim 19, wherein providing a loan to each of the owners comprises providing a loan of less than or equal to about 65% of the present market value of the respective equity securities deposited by each owner.

28. The method of claim 19, further comprising:
determining the current market value of an owner's equity securities in the exchange fund at a respective warrant maturity date;
allowing the owner to repurchase the equity securities at the current market value if the current market value is greater than or equal to the market value of the equity securities at the time of deposit; and
requiring the owner to repurchase the equity securities at the market value of the equity securities at the time of deposit if the current market value is less than the market value of the equity securities at the time of deposit.

29. The method of claim 19, wherein the equity securities are restricted equity securities or low cost basis securities.

30. An underwriter system for providing tax-deferred liquidity to owners of highly concentrated positions in equity securities, comprising:
an exchange fund that comprises a plurality of diversified equity securities and that has a maturity date;
means for accepting deposits of equity securities into the exchange fund from a plurality of owners of highly concentrated positions in the equity securities;
means for providing each of the owners a respective ownership position in the exchange fund;
means for providing a loan to each of the owners, wherein each loan is based on the market value of the equity securities deposited by a respective owner at the time of deposit; and
means for accepting from each owner a warrant to repurchase the equity securities deposited by each respective owner at a future warrant maturity date.

31. The system of claim 30, wherein the exchange fund comprises a plurality of diversified equity securities, and wherein the exchange fund has a maturity date.

32. The system of claim 30, wherein each equity securities owner maintains ownership rights in the owner's respective equity securities.

33. The system of claim 30, wherein each respective ownership position is proportionate to the market value of the equity securities deposited by each owner at the time of deposit.

34. The system of claim 30, wherein each loan is based on a percentage of the market value of the equity securities deposited by a respective owner at the time of deposit, and wherein each loan is required to be paid in full at a respective future maturity date.

35. The system of claim 30, wherein means for accepting from each owner a warrant to repurchase the equity securities deposited by each respective owner at a future warrant maturity date comprises means for accepting from each owner a warrant to repurchase the equity securities deposited by each respective owner at the market value at the time of deposit.

36. The system of claim 30, further comprising:
means for bundling the warrants and loans to create a plurality of exchange notes, wherein each exchange note has a rate of return and a maturity date at which time the exchange note can be redeemed; and
means for selling the exchange notes to investors.

37. The system of claim 30, wherein the exchange fund has a requirement that equity securities deposited therein meet an aggregate diversity requirement, and wherein means for accepting deposits of equity securities into the exchange fund from the plurality of owners comprises means for verifying that the aggregate diversity requirement is satisfied.

38. The system of claim 30, wherein means for providing a loan to each of the owners comprises means for providing a loan of less than or equal to about 65% of the present market value of the respective equity securities deposited by each owner.

39. The system of claim 30, further comprising:
means for determining the current market value of an owner's equity securities in the exchange fund at a respective warrant maturity date;
means for allowing the owner to repurchase the equity securities at the current market value if the current market value is greater than or equal to the market value of the equity securities at the time of deposit; and
means for requiring the owner to repurchase the equity securities at the market value of the equity securities at the time of deposit if the current market value is less than the market value of the equity securities at the time of deposit.

40. The system of claim 30, wherein the equity securities are restricted equity securities or low cost basis securities.

41. A computer program product for providing tax-deferred liquidity to owners of highly concentrated positions in equity securities, the computer program product comprising a computer usable storage medium having computer readable program code embodied in the medium, the computer readable program code comprising:
computer readable program code that accepts deposits of equity securities into the exchange fund from a plurality of owners of highly concentrated positions in the equity securities;
computer readable program code that provides each of the owners a respective ownership position in the exchange fund;
computer readable program code that provides a loan to each of the owners, wherein each loan is based on the market value of the equity securities deposited by a respective owner at the time of deposit; and
computer readable program code that accepts from each owner a warrant to repurchase the equity securities deposited by each respective owner at a future warrant maturity date.

42. The computer program product of claim 41, wherein the exchange fund comprises a plurality of diversified equity securities, and wherein the exchange fund has a maturity date.

43. The computer program product of claim 41, wherein each equity securities owner maintains ownership rights in the owner's respective equity securities.

44. The computer program product of claim 41, wherein each respective ownership position is proportionate to the market value of the equity securities deposited by each owner at the time of deposit.

45. The computer program product of claim 41, wherein each loan is based on a percentage of the market value of the equity securities deposited by a respective owner at the time of deposit, and wherein each loan is required to be paid in full at a respective future maturity date.

46. The computer program product of claim 41, wherein the computer readable program code that accepts from each owner a warrant to repurchase the equity securities deposited by each respective owner at a future warrant maturity date comprises computer readable program code that accepts from each owner a warrant to repurchase the equity securities deposited by each respective owner at the market value at the time of deposit.

47. The computer program product of claim 41, further comprising:
computer readable program code that bundles the warrants and loans to create a plurality of exchange notes, wherein each exchange note has a rate of return and a maturity date at which time the exchange note can be redeemed; and
computer readable program code that sells the exchange notes to investors.

48. The computer program product of claim 41, wherein the exchange fund has a requirement that equity securities deposited therein meet an aggregate diversity requirement, and wherein the computer readable program code that accepts deposits of equity securities into the exchange fund from the plurality of owners comprises computer readable program code that verifies that the aggregate diversity requirement is satisfied.

49. The computer program product of claim 41, wherein the computer readable program code that provides a loan to each of the owners comprises computer readable program code that provides a loan of less than or equal to about 65% of the present market value of the respective equity securities deposited by each owner.

50. The computer program product of claim 41, further comprising:
computer readable program code that determines the current market value of an owner's equity securities in the exchange fund at a respective warrant maturity date;
computer readable program code that allows the owner to repurchase the equity securities at the current market value if the current market value is greater than or equal to the market value of the equity securities at the time of deposit; and
computer readable program code that requires the owner to repurchase the equity securities at the market value of the equity securities at the time of deposit if the current market value is less than the market value of the equity securities at the time of deposit.

51. The computer program product of claim 41, wherein the equity securities are restricted equity securities or low cost basis securities.
